(19) United States
(12) Patent Application Publication
(10) Pub. No.: US 2007/0027265 A1
(43) Pub. Date: Feb. 1, 2007

(54) Copolymers containing sulfonic acid groups and carboxyl groups

(75) Inventors: Marcus Guzmann, Muhlhausen (DE); Heike Becker, Mannheim (DE); Kathrin Michl, Ludwigshafen (DE); Arend Jouke Kingma, Ludwigshafen (DE); Stefan Nied, Neustadt (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/568,970

(22) PCT Filed: Jul. 15, 2004
(86) PCT No.: PCT/EP04/07863

§ 371 Date: Feb. 22, 2006

(30) Foreign Application Priority Data
Aug. 25, 2003 (DE) 103 39 332.3

(51) Int. Cl. C08F 120/02

(52) U.S. Cl. 525/329.7; 525/340; 526/317.1

(57) ABSTRACT

Copolymers of (A1) 70 to 100 mol % of at least two different monoethylenically unsaturated carboxylic acid monomers and (A2) 0 to 30 mol % of one or more nonionic monomers, which have been reacted with
(B) 5 to 30 mol %, based on the amidatable functional groups present in the copolymer of the monomers (A1) and if desired (A2), of an amino-C₁-C₂-alkanesulfonic acid and/or a salt thereof, and the preparation of the copolymers and their use in detergents, cleaners and rinse aids.

The present invention relates to copolymers of
(A1) 70 to 100 mol % of at least two different monoethylenically unsaturated carboxylic acid monomers and
(A2) 0 to 30 mol % of one or more nonionic monomers,
   which have been reacted with
(B) 5 to 30 mol %, based on the amidatable functional groups present in the copolymer of the monomers (A1) and if desired (A2), of an amino-C₁-C₂-alkanesulfonic acid and/or a salt thereof.

In addition, the invention relates to the preparation of these copolymers and their use in detergents, cleaners and rinse aids, and also to detergents, cleaners and rinse aids which comprise these copolymers.

In the case of machine dishwashing, the ware should be obtained in a residue-free cleaned state with a flawlessly gleaming surface. The ware should not only be completely cleaned of food residues, but should also have no whitish marks which arise due to the presence of limescale or other inorganic and organic salts during the drying up of water drops.

For this reason, rinse aids have been used for a relatively long time. Here, the rinse aid is automatically released from a dosing tank in the inside of the dishwasher in the clear-rinse cycle following completion of the wash program which usually consists of a prewash cycle and a main wash cycle interrupted by interim wash cycles, and ensures that the water during the clear-rinse cycle and drying cycle runs off from the ware in a manner which is flat and as complete as possible.

In the case of the so-called 2 in 1 dishwashing detergents on the market, clear-rinse surfactants have already been incorporated into the detergent formulation. Filling of the rinse aid dosing tank is no longer necessary when these products are used.

In modern machine dishwashing detergents, the 3 in 1 detergents, the three functions of cleaning, clear rinsing and water softening are combined in a single detergent formulation, meaning that both the topping-up of salt (for water hardnesses from 1 to 3) and also of rinse aid become superfluous for the consumer. To bind the hardness-forming calcium and magnesium ions in the main wash cycle, sodium or potassium tripolyphosphate is usually added to these detergents. Nevertheless, the addition of these phosphates results, particularly in the clear-rinse cycle when their concentration is reduced, in calcium and magnesium phosphate films on the ware.

WO-A-01/96514 describes film inhibitors based on copolymers of olefinically unsaturated monomers containing carboxyl groups and copolymerizable sulfonated and/or copolymerizable nonionic monomers which are released at least partially in the penultimate wash cycle of the dishwashing program. Copolymers which also comprise methacrylic acid besides acrylic acid, however, are neither explicitly disclosed nor highlighted as being preferred. In addition, all copolymers are prepared by copolymerization of correspondingly functionalized monomers, thus, for example, of acrylic acid and 2-acrylamido-2-methylpropanesulfonic acid. These copolymers are also known from EP-A-851 022 as additives for rinse aids which inhibit calcium phosphate films.

According to EP-A-877 002, copolymers obtained by copolymerization of strongly acidic and weakly acidic acid monomers are suitable for inhibiting (poly)phosphate films in aqueous systems. Again, only copolymers of acrylic acid and 2-acrylamido-2-propanesulfonic acid are explicitly disclosed.

In addition, U.S. Pat. No. 4,801,388 discloses the use of copolymers prepared by copolymerization of (meth)acrylic acid with (meth)acrylamidoalkanesulfonic acids as inhibitors of phosphate films. However, the explicitly disclosed copolymers comprise no methacrylic monomer. Preference is given to terpolymers which additionally comprise copolymerized acrylamide.

WO-A-02/04583 and 03/06594 describe 2 in 1 and 3 in 1 dishwashing compositions which comprise copolymers obtained by copolymerization of unsaturated carboxylic acids with monomers containing sulfonic acid groups in combination with relatively large amounts of nonionic surfactants and/or polycarboxylic acids for the spot-free drying of the ware. For preferred copolymers, acrylic acids, methacrylic acid and maleic acid and, inter alia, 1-(meth)acrylamido-1-propanesulfonic acid and 2-(meth)acrylamido-2-propanesulfonic acid are mentioned as monomers. According to WO-A-02/26926, these copolymers can also be used in detergent and cleaning tablets with a high content of nonionic surfactants.

Finally, U.S. Pat. No. 4,604,431 discloses the polymer-analogous reaction of polyacrylic acid or polymethacrylic acid with aminoalkanesulfonic acids for partial conversion of the carboxyl groups into amidoalkylsulfonic acid groups. The reaction of polyacrylic acid with aminoethanesulfonic acid (taurine) is explicitly disclosed.

It is an object of the present invention to provide additives which are notable for advantageous application properties, in particular for their film-inhibiting effect and broad usability in the field of machine dishwashing.

We have found that this object is achieved by copolymers of
(A1) 70 to 100 mol % of at least two different monoethylenically unsaturated carboxylic acid monomers and
(A2) 0 to 30 mol % of one or more nonionic monomers,
   which have been reacted with
(B) 5 to 30 mol %, based on the amidatable functional groups present in the copolymer of the monomers (A1) and if desired (A2), of an amino-C₁-C₂-alkanesulfonic acid and/or a salt thereof.

The copolymers according to the invention are prepared by polymer-analogous reaction, i.e. firstly the carboxylic acid monomers (A1) and, if desired, the nonionic monomers (A2) are copolymerized, and only the resulting copolymer is reacted to give the copolymer containing sulfoalkylamide groups. They differ from copolymers which have been prepared by polymerization of carboxylic acid and carboxylic acid amidoalkanesulfonic acid monomers since the varying reactivity of the monomers used results in an arrangement of the functional groups on the polymer backbone which is specific in each case.

Carboxylic acid monomers (A1) preferred for the copolymers according to the invention include the group of monoethylenically unsaturated C₃-C₆-monocarboxylic acids, of monoethylenically unsaturated C₄-C₈-dicarboxylic acids and their anhydrides and the salts of mono- and dicarboxylic acids.

Specifically, examples of suitable monomers (A1) are: acrylic acid, methacrylic acid, 2-ethylpropenoic acid, crotonic acid and vinylacetic acid, and also itaconic acid, maleic acid and maleic anhydride, preference being given to acrylic acid, methacrylic acid and maleic acid (anhydride), and particular preference being given to acrylic acid and methacrylic acid.

The carboxylic acid monomers (A1) can of course also be used in the form of their salts. Preference is given to water-soluble salts, in particular the alkali metal salts, primarily the sodium and potassium salts, and also the ammonium salts, particular preference being given to the sodium salts.

The copolymers according to the invention can also comprise one or more nonionic monomers (A2) in copolymerized form.

Examples of nonionic comonomers (A2) are:
esters of monoethylenically unsaturated C₃-C₆-carboxylic acids, especially acrylic acid and methacrylic acid, with monohydric C₁-C₂₂-alcohols, in particular C₁-C₁₆-alcohols; and hydroxyalkyl esters of monoethylenically unsaturated C₃-C₆-carboxylic acids, especially acrylic acid and methacrylic acid, with dihydric C₂-C₄-alcohols, such as methyl (meth)acrylate, ethyl (meth)acrylate, n-butyl (meth)acrylate, sec-butyl (meth)acrylate, tert-butyl (meth)acrylate, ethylhexyl (meth)acrylate, decyl (meth)acrylate, lauryl (meth)acrylate, isobornyl (meth)acrylate, cetyl (meth)acrylate, palmityl (meth)acrylate and stearyl (meth)acrylate, hydroxyethyl (meth)acrylate, hydroxypropyl (meth)acrylate and hydroxybutyl (meth)acrylate;
amides of monoethylenically unsaturated C₃-C₆-carboxylic acids, especially acrylic acid and methacrylic acid, with C₁-C₁₂-alkylamines and di(C₁-C₄-alkyl)amines, such as N-methyl(meth)acrylamide, N,N-dimethyl(meth)acrylamide, N-ethyl(meth)acrylamide, N-propyl(meth)acrylamide, N-tert-butyl(meth)acrylamide, N-tert-octyl(meth)acrylamide and N-undecyl(meth)acrylamide, and (meth)acrylamide;
vinyl esters of saturated C₂-C₃₀-carboxylic acids, in particular C₂-C₁₄-carboxylic acids, such as vinyl acetate, vinyl propionate, vinyl butyrate, vinyl 2-ethyl-hexanoate and vinyl laurate;
vinyl C₁-C₃₀-alkyl ethers, in particular vinyl C₁-C₁₈-alkyl ethers, such as vinyl methyl ether, vinyl ethyl ether, vinyl n-propyl ether, vinyl isopropyl ether, vinyl n-butyl ether, vinyl isobutyl ether, vinyl 2-ethylhexyl ether and vinyl octadecyl ether;
N-vinylamides and N-vinyllactams, such as N-vinylformamide, N-vinyl-N-methylformamide, N-vinylacetamide, N-vinyl-N-methylacetamide, N-vinylpyrrolidone, N-vinylpiperidone and N-vinylcaprolactam;
aliphatic and aromatic olefins, such as ethylene, propylene, C₄-C₂₄-α-olefins, in particular C₄-C₁₆-α-olefins, e.g. butylene, isobutylene, diisobutene, styrene and α-methylstyrene, and also diolefins with an active double bond, e.g. butadiene;
unsaturated nitriles, such as acrylonitrile and methacrylonitrile.

If the monomers (A2) are present in the copolymers according to the invention, then their content is usually 0.5 to 30 mol %, preferably 1 to 10 mol %, based on the copolymer of (A1) and (A2).

However, the copolymers according to the invention are preferably based on a copolymer made up only of the monomers (A1) and particularly preferably only of methacrylic acid, acrylic acid and/or maleic acid.

Very particular preference is given to copolymers of methacrylic acid and acrylic acid. The molar ratio of methacrylic acid and acrylic acid is usually 10:1 to 1:5, in particular 9:1 to 1:3, especially 9:1 to 1:2.

The copolymers according to the invention of monomers (A1) and, if desired, monomers (A2) are reacted with an amino-C₁-C₂-alkanesulfonic acid and/or a salt of this acid (B), as a result of which some of the amidatable functional groups present in the copolymer are converted into the corresponding N-sulfoalkylamide groups. These are, in particular, the carboxyl groups of the monomers (A1). If the copolymers also comprise nonionic monomers (A2) with ester or amide groups, then these may also be amidated or transamidated.

Suitable amino-C₁-C₂-alkanesulfonic acids (B) are aminomethanesulfonic acid and 2-aminoethanesulfonic acid, preference being given to 2-aminoethanesulfonic acid.

The aminoalkanesulfonic acids (B) can be used in a free form or in the form of salts. In turn, preferred salts are the alkali metal salts, in particular the sodium salts. It is of course also possible to use mixtures of 2-aminoethanesulfonic acid and aminomethanesulfonic acid.

According to the invention, the copolymers of the monomers (A1) and, if desired, (A2) are reacted with 5 to 30 mol %, preferably with 6 to 17 mol %, particularly preferably with 7 to 14 mol %, of aminoalkanesulfonic acid, in each case based on the amidatable functional groups present in the copolymer of (A1) and, if desired, (A2).

Accordingly, the copolymers according to the invention have a composition of from 65 to 97 mol %, in particular 73 to 97 mol %, especially 80 to 95 mol %, of the monomers (A1) and, if desired, (A2) and 3 to 35 mol %, in particular 3 to 27 mol %, especially 5 to 20 mol %, of the aminoalkanesulfonic acid (B).

The copolymers according to the invention usually have an average molecular weight M_{w} of from 3000 to 50 000, preferably from 10 000 to 35 000 and particularly preferably from 15 000 to 25 000 (determined by gel permeation chromatography at room temperature using an aqueous eluent).

The K value of the copolymers is usually 12 to 40, in particular 15 to 32, especially 18 to 30 (measured in 1% strength by weight aqueous solution at a pH of 7.2 and 25° C., in accordance with H. Fikentscher, Cellulose-Chemie, Vol. 13, pp. 58-64 and 71-74 (1932)).

The copolymers according to the invention can advantageously be prepared by the process which is likewise provided by the invention and which comprises
a) copolymerizing at least two of the monomers (A1) and, if desired, one or more of the monomers (A2) free-radically with one another and
b) reacting the copolymer obtained in step a) with an amino-C₁-C₂-alkanesulfonic acid and/or a salt of this acid.

In step a), any known free-radical polymerization process may be used. Besides bulk polymerization, the processes of solution polymerization and of emulsion polymerization in particular are to be mentioned, with preference being given to solution polymerization.

The polymerization is preferably carried out in water as solvent. It can, however, also be carried out in alcoholic solvents, in particular C₁-C₄-alcohols, such as methanol, ethanol and, preferably, isopropanol, or mixtures of these solvents with water, especially mixtures of water and isopropanol.

Suitable polymerization initiators are compounds which either decompose thermally or photochemically (photoinitiators) to form free radicals.

Among the thermally activable polymerization initiators, preference is given to initiators with a decomposition temperature in the range from 20 to 180° C., in particular from 50 to 90° C. Examples of suitable thermal initiators are inorganic peroxo compounds, such as peroxodisulfates (ammonium and preferably sodium peroxodisulfate), peroxosulfates, percarbonates and hydrogen peroxide; organic peroxo compounds, such as diacetyl peroxide, di-tert-butyl peroxide, diamyl peroxide, dioctanoyl peroxide, didecanoyl peroxide, dilauroyl peroxide, dibenzoyl peroxide, bis(o-tolyl)peroxide, succinyl peroxide, tert-butyl peracetate, tert-butyl permaleate, tert-butyl perisobutyrate, tert-butyl perpivalate, tert-butyl peroctoate, tert-butyl perneodecanoate, tert-butyl perbenzoate, tert-butyl peroxide, tert-butyl hydroperoxide, cumene hydroperoxide, tert-butyl peroxy-2-ethylhexanoate and diisopropyl peroxydicarbamate; azo compounds, such as 2,2′-azobisisobutyronitrile, 2,2′-azobis(2-methylbutyronitrile) and azobis(2-amidopropane)dihydrochloride.

These initiators can be used in combination with reducing compounds as starter/regulator systems. Examples of such reducing compounds which may be mentioned are phosphorus-containing compounds, such as phosphorous acid, hypophosphites and phosphinates, sulfur-containing compounds, such as sodium hydrogensulfite, sodium sulfite and sodium formaldehyde sulfoxylate, and hydrazine.

Examples of suitable photoinitiators are benzophenone, acetophenone, benzoin ether, benzyl dialkyl ketones and derivatives thereof.

Preferably, thermal initiators are used, preference being given to inorganic peroxo compounds, in particular sodium peroxodisulfate (sodium persulfate) and hydrogen peroxide.

The peroxo compounds are advantageously used in combination with sulfur-containing reducing agents, in particular sodium hydrogensulfite, as redox initiator system. The use of this starter/regulator system produces copolymers which comprise —SO₃⁻Na⁺ and/or —SO₄⁻Na⁺ as end groups and may be notable for particular cleaning power and film-inhibiting effect.

Alternatively, it is also possible to use phosphorus-containing starter/regulator systems, e.g. hypophosphites/phosphinates.

The amounts of photoinitiator and/or starter/regulator system are to be matched to the monomers used in each case. If, for example, the preferred system of peroxodisulfate/hydrogensulfite is used, then usually 2 to 6% by weight, preferably 3 to 5% by weight, of peroxodisulfate and usually 5 to 30% by weight, preferably 5 to 10% by weight, of hydrogensulfite, are used, in each case based on the sum of the monomers.

If desired, it is also possible to use polymerization regulators. Suitable compounds are those known to the person skilled in the art, e.g. sulfur compounds, such as mercaptoethanol, 2-ethylhexyl thioglycolate, thioglycolic acid and dodecyl mercaptan.

If polymerization regulators are used, their use amount is usually 0.1 to 15% by weight, preferably 0.1 to 5% by weight and particularly preferably 0.1 to 2.5% by weight, based on the sum of the monomers.

The polymerization temperature is usually 30 to 200° C., preferably 50 to 150° C. and particularly preferably 80 to 130° C.

The polymerization is preferably carried out under protective gas, such as nitrogen or argon, and can be carried out under atmospheric pressure, although it is preferably carried out in a closed system under the autogenous pressure which develops.

The copolymer according to the invention is obtained in step a) preferably in the form of a polymer solution which has a solids content of usually 10 to 70% by weight.

In step b), the copolymer obtained in step a), preferably in the form of the solution which forms, is reacted in a polymer-analogous reaction with (B) with the aminoalkanesulfonic acid and/or a salt of this acid, as a result of which some of the amidatable functional groups present in the copolymer are converted to the corresponding N-sulfoalkylamide groups.

Expediently, the copolymer solution is firstly adjusted to a pH of from preferably 2.0 to 9.0, in particular 4.0 to 7.5, especially 4.5 to 7 by adding a base. For this purpose, all organic and inorganic bases are suitable in principle, although preference is given to using aqueous solutions of alkali metal hydroxides, e.g. sodium hydroxide solution.

The use amount of aminoalkanesulfonic acid is chosen here such that the molar ratio of amidatable functional groups present in the copolymer to aminoalkanesulfonic acid is usually 19:1 to 2:1, preferably 15:1 to 5:1 and particularly preferably 13:1 to 6:1.

The amidation temperature is usually 140 to 250° C., preferably 165 to 200° C. and particularly preferably 165 to 200° C.

The amidation is likewise expediently carried out under protective gas, such as nitrogen or argon, under atmospheric pressure but preferably under the autogenous pressure which develops in the closed system (pressure from generally 1 to 25 bar, in particular 5 to 17 bar, especially 7 to 13 bar).

If desired for the application, the aqueous solutions preferably produced during the preparation of the copolymers according to the invention can be neutralized or partially neutralized, i.e. to a pH in the range from 4 to 8, preferably from 4.5 to 7.5, by adding organic or, in particular, inorganic bases, in particular sodium hydroxide solution.

The copolymers according to the invention are exceptionally suitable as additive in detergents, cleaners and rinse aids.

They can be used particularly advantageously in detergents and rinse aids for dishwashers. They are characterized primarily by their film-inhibiting effect both toward inorganic and also organic films, meaning that they are suitable both for use in separately dosed rinse aids and also for use in the rinse aid function of co-performing 2 in 1 and 3 in 1 dishwashing detergents.

Their use amounts are usually 0.1 to 20% by weight, preferably 1 to 10% by weight, in detergent tablets and detergent powders and usually 0.1 to 10% by weight, preferably 1 to 6% by weight, in rinse aids, in each case based on the detergent or rinse aid formulation.

The copolymers according to the invention have an inhibiting effect both for films which are caused by the constituents of the detergent formulation which are intended to reduce water hardness, such as films of calcium and magnesium phosphate, calcium and magnesium silicate and calcium and magnesium phosphonate, and also films which originate from the soil constituents of the wash liquor, such as grease, protein and starch films. As a result of their film-inhibiting effect, the copolymers used according to the invention improve the cleaning result with lasting effect. Additionally, even in low concentrations, they favor run-off of the water from the ware, meaning that the amount of clear-rinse surfactants in the dishwashing detergent can be reduced. If the claimed copolymers are used, particularly clear glassware and gleaming metal cutlery items are obtained, particularly also when the dishwasher is operated without regenerating salt to soften the water.

The copolymers according to the invention can be used directly in the form of the aqueous solutions produced during the preparation, or else in dried form obtained, for example, by spray drying, fluidized spray drying, drum drying or freeze-drying.

The copolymers according to the invention can, for example, be used as follows:
dissolved in a clear-rinse formulation which is automatically metered in the dishwasher at the start of the clear-rinse cycle.
in the form of a solid obtained by one of the methods described above, which is additionally provided with a coating which is soluble under the clear-rinse conditions (temperature, pH, residual concentration of detergent components in the clear-rinse cycle), or is incorporated into a matrix which is soluble under these conditions, and is introduced into the machine with the detergent, but is only released in the clear-rinse cycle.
A suitable coating material for this purpose is, for example, polyvinyl alcohol prepared by incomplete hydrolysis of polyvinyl acetate (degree of hydrolysis of usually 88 to 98%, preferably 89 to 95%, particularly preferably 91 to 92%).
Suitable matrix materials are, for example, gelatin, polyvinyl alcohol, polyvinylpyrrolidone, polyethylene oxide, cellulose and derivatives thereof, starch and derivatives thereof and mixtures of these materials.
formulated in the rinse aid core of a dishwashing detergent tablet, from where it is released in a targeted manner in the clear-rinse cycle.

### EXAMPLES

I) Preparation of Copolymers According to the Invention

### Example 1

a) Copolymerization

324 g of water were heated under nitrogen to an internal temperature of 100° C. in a reactor fitted with stirrer, nitrogen inlet, reflux condenser and metering device. A mixture of 107 g of acrylic acid and 242 g of methacrylic acid in 230 g of water and, in parallel to this, a solution of 14 g of sodium peroxodisulfate in 78 g of water were then metered in continuously over 4 h. After after-stirring for one hour at 100° C., the reaction mixture was cooled to room temperature.

This gave a clear copolymer solution with a solids content of 35% by weight. The K value of the copolymer was 50 (1% strength by weight in water, pH 7, 25° C.).

b) Amidation

In a pressure-stable reaction vessel fitted with stirrer, nitrogen inlet, temperature sensor, pressure indicator and bleed option, a mixture of 1000 g of the copolymer solution obtained in step a) and diluted to a solids content of 25% by weight and 43.5 g of 2-aminoethanesulfonic acid (taurine) was adjusted to a pH of 6 by adding 183.0 g of 50% strength by weight sodium hydroxide solution. After flushing with nitrogen three times and sealing the vessel, the mixture was heated to an internal temperature of 180° C. with stirring, during which a pressure of about 12 bar built up. After stirring for five hours at 180° C., the reaction mixture was cooled to room temperature without decompression. The vessel was then opened. 14.0 g of 50% strength by weight sodium hydroxide solution were then added to establish a pH of 7.2.

This gave a clear yellow solution with a solids content of 31.7% by weight. The K value of the amidated copolymer was 23.8 (1% strength by weight in 3% strength by weight aqueous NaCl solution, pH 7.2, 25° C.).

### Example 2

The procedure was analogous to Example 1, but using, in step b), 33.4 g of taurine, and prior to the reaction 173 g and after the reaction 18.9 g of 50% strength by weight sodium hydroxide solution.

This gave a clear yellow solution with a solids content of 50% by weight. The K value of the amidated copolymer was 24.9 (1% strength by weight in 3% strength by weight aqueous NaCl solution, pH 7.2, 25° C.).

### Example 3

a) Copolymerization

1016 g of a water/isopropanol mixture (weight ratio 80/20) were heated under nitrogen to an internal temperature of 100° C. in a reactor fitted with stirrer, nitrogen inlet, reflux condenser and metering device. A mixture of 472 g of acrylic acid and 1102 g of methacrylic acid in 449 g of water were then added over 4 h and, in parallel to this, a solution of 120 g of hydrogen peroxide (30% strength by weight) in 200 g of a water/isopropanol mixture (weight ratio 80/20) was metered in continuously over 6 h. A further 200 g of the water/isopropanol mixture were then used to rinse the feed. Following after-stirring for one hour at 100° C., the reaction mixture was cooled to room temperature.

This gave a clear copolymer solution with a solids content of 34% by weight. The K value of the copolymer was 75.3 (1% strength by weight in water, pH 7, 25° C.).

b) Amidation

In a pressure-stable reaction vessel fitted with stirrer, nitrogen inlet, temperature sensor, pressure indicator and bleed option, a mixture of 800 g of the copolymer solution obtained in step a) and diluted with 200 g of water, and 61.6 g of 2-aminoethanesulfonic acid (taurine) was adjusted to a pH of 6 by adding 207.0 g of 50% strength by weight sodium hydroxide solution. After flushing with nitrogen three times and sealing the vessel, the mixture was heated to an internal temperature of 180° C. with stirring, during which a pressure of about 9.6 bar built up. After stirring for five hours at 180° C., the reaction mixture was cooled to room temperature without decompression. The vessel was then opened. 6.3 g of 96% strength by weight sulfuric acid were then added to establish a pH of 7.2.

This gave a clear yellow solution with a solids content of 34.9% by weight. The K value of the amidated copolymer was 55.7 (1% strength by weight in water, pH 7.2, 25° C.).

II) Use of Copolymers According to the Invention in Machine Dishwashing Detergents

a) Film Inhibition

To test their film-inhibiting effect, the resulting copolymers were used together with a dishwashing detergent formulation of the following composition:

50% by weight sodium tripolyphosphate (Na₃P₃O₁₀.6H₂O)

27% by weight sodium carbonate

3% by weight sodium disilicate (xNa₂O.ySiO₂; x/y=2.65; 80% strength)

6% by weight sodium percarbonate (Na₂CO₃.1.5H₂O)

2% by weight tetraacetylethylenediamine (TAED)

2% by weight low-foam nonionic surfactant based on fatty alcohol alkoxylates

3% by weight sodium chloride

5% by weight sodium sulfate

2% by weight polyacrylic acid sodium salt (M_{w} 8000)

The test was carried out at the following washing conditions without the addition of ballast soiling, with neither rinse aid nor regenerating salt being used:
Dishwasher: Miele G 686 SC
Wash cycles: 2 wash cycles at 55° C. normal (without prewash)
Ware: knives (WMF Tafelmesser Berlin, Monoblock) and barrel-shaped glass beakers (Matador, Ruhr Kristall)
Dishwashing detergent: 21 g
Copolymer: 4.2 g
Clear-rinse temperature: 65° C.
Water hardness: 25° German hardness

The ware was evaluated 18 h after washing by visual assessment in a black-painted light box with halogen spotlight and aperture plate using a grading scale from 10 (very good) to 1 (very poor). The highest grade 10 corresponds here to film- and drop-free surfaces, from grades<5, films and drops are visible even in normal room lighting, and are therefore regarded as being troublesome.

The test results obtained are listed in table 1. For comparison, the results are listed here which were obtained using a copolymer of acrylic acid and 2-amino-2-methylpropanesulfonic acid (molar ratio 80:20, M_{w} 20 000) (comparative example C1) or without use of an additional copolymer.

TABLE 1

Evaluation (grade)

| Copolymer from Ex. | Knives | Glassware |
|---|---|---|
| 1 | 8.0 | 8.3 |
| 2 | 7.0 | 8.8 |
| 3 | 8.3 | 8.2 |
| C1 | 7.3 | 8.3 |
| — | 4.0 | 6.0 |

b) Clear-Rinse Effect

To test their clear-rinse effect, the resulting copolymers were used together with a standard commercial 3 in 1 dishwashing detergent formulation in tablet form (Somat), the copolymers only being added in the clear-rinse cycle in order to simulate delayed release of further copolymer.

However, the test was carried out in the presence of IKW ballast soiling (SÖFW Journal, 124^{th} volume, 14/98, p. 1029) under the following washing conditions:
Dishwasher: Miele G 686 SC
Wash cycles: 1 wash cycle, 55° C.
Ware: knives (WMF Tafelmesser Berlin, Monoblock); glasses (lager, 0.3 l); black dessert plates (ceramic); black plastic plates (SAN); EMSA Superline—Box (cover PE blue, can PP transparent)
Dishwashing detergent: 1 tablet of Somat 3 in 1
Ballast soiling: addition of 50 g in the main wash cycle, 2 g in the clear-rinse cycle
Copolymer: 210 mg in the clear-rinse cycle
Clear-rinse temperature: 65° C.
Water hardness: 21° German hardness

At the end of the wash cycle, the door was opened and the dishes were left to dry for 60 minutes with the door open. The ware was then evaluated by visual assessment in the light box described under a) using a grading scale from 0 (very poor; very severe formation of dried drops (spotting), i.e. more than 50% of the surface covered with dried drops, filming) to 4 (very good, no spots, no filming).

The test results obtained are summarized in table 2, the results with copolymer C1 and without the addition of copolymer again being listed for comparison.

TABLE 2

| | Evaluation (grade) | | |
|---|---|---|---|
| Copolymer | | Knives, glasses, ceramic plates | Plastic parts |

| from Ex. | Spotting | Filming | Spotting |
|---|---|---|---|
| 1 | 2.2 | 2.9 | 1.2 |
| 2 | 1.8 | 3.2 | 1.2 |
| C1 | 1.7 | 2.9 | 1.1 |
| — | 1.8 | 2.0 | 0.8 |

1. A copolymer comprising
(A1) 70 to 100 mol % of at least two different monoethylenically unsaturated carboxylic acid monomers and
(A2) 0 to 30 mol % of one or more nonionic monomers,
which have been reacted with
(B) 5 to 30 mol %, based on the amidatable functional groups present in the copolymer of the monomers (A1) and optionally (A2), of an amino-C₁-C₂-alkanesulfonic acid, a salt of an amino-C₁-C₂-alkanesulfonic acid, or a combination thereof.

2. The copolymer according to claim 1, which comprises, in copolymerized form, as component (A1), at least two monomers selected from the group consisting of monoethylenically unsaturated C₃-C₆-monocarboxylic acids, monoethylenically unsaturated C₄-C₈-dicarboxylic acids, anhydrides of monoethylenically unsaturated C₃-C₆-monocarboxylic acids, anhydrides of momoethylenically unsaturated C₄-C₈-dicarboxylic acids, salts of monoethylenically unsaturated C₃-C₆-monocarboxylic acids, salts of momoethylenicallv unsaturated C₄-C₈-dicarboxylic acids, and combinations thereof.

3. The copolymer of claim 1, which is made up only of the monomers (A1).

4. The copolymer of claim 1, which comprises, in copolymerized form, as the monomers (A1), methacrylic acid, acrylic acid, maleic acid, or combinations thereof.

5. The copolymer of claim 1, which comprises, in copolymerized form, as the monomers (A1), methacrylic acid and acrylic acid in the molar ratio 9:1 to 1:2.

6. The copolymer of claim 1, wherein the component (B) comprises 2-aminoethanesulfonic acid, a salt of 2-aminoethanesulfonic acid, or a combination thereof.

7. A process for preparing the copolymer of claim 1, comprising
a) copolymerizing at least two of the monomers (A1) and, optionally, one or more of the nonionic monomers (A2) free-radically with one another to obtain a precursor copolymer and
b) reacting the precursor copolymer obtained in a) with an amino-C₁-C₂-alkanesulfonic acid, a salt of an amino-C₁-C₂-alkanesulfonic acid, or a combination thereof, to form the copolymer.

8. (canceled)

9. A method of making a detergent, comprising, forming the detergent with the copolymer of claim 1.

10. A composition comprising the copolymer of claim 1 and at least one additive selected from the group consisting of a gelatin, a polyvinyl alcohol, a polyvinylpyrrolidone, a polyethylene oxide, cellulose, starch, sodium tripolyphosphate, sodium carbonate, sodium disilicate, sodium percarbonate, tetraacetylethylenediamine, a low-foam nonionic surfactant, sodium chloride, sodium sulfate, a polyacrylic acid sodium salt, and combinations thereof.

11. A method of cleaning dishware comprising, cleaning the dishware with the composition of claim 10.

12. The composition of claim 10, wherein the at least one additive comprises a low-foam nonionic surfactant.

13. The copolymer of claim 2, which comprises, in copolymerized form, as the monomers (A1), methacrylic acid, acrylic acid, maleic acid, or combinations thereof.

14. The copolymer of claim 3, which comprises, in copolymerized form, as the monomers (A1), methacrylic acid, acrylic acid, maleic acid, or combinations thereof.

15. The copolymer of claim 2, which comprises, in copolymerized form, as the monomers (A1), methacrylic acid and acrylic acid in the molar ratio 9:1 to 1:2.

16. The copolymer of claim 3, which comprises, in copolymerized form, as the monomers (A1), methacrylic acid and acrylic acid in the molar ratio 9:1 to 1:2.

17. The copolymer of claim 3, which comprises, in copolymerized form, as the monomers (A1), methacrylic acid and acrylic acid in the molar ratio 9:1 to 1:2.

18. A method of making a detergent, comprising, forming the detergent with the copolymer of claim 2.

19. A method of making a detergent, comprising, forming the detergent with the copolymer of claim 4.

20. A method of making a detergent, comprising, forming the detergent with the copolymer of claim 5.

21. A method of making a detergent, comprising, forming the detergent with the copolymer of claim 6.
